(19) United States
(12) Patent Application Publication
(10) Pub. No.: US 2007/0108744 A1
(43) Pub. Date: May 17, 2007

(54) Safety air bag

(76) Inventor: Alojz Hanuliak, Brno (CZ)

Correspondence Address: OSTROLENK FABER GERB & SOFFEN, 1180 AVENUE OF THE AMERICAS, NEW YORK, NY, 100368403, US

(21) Appl. No.: 10/560,206

(22) PCT Filed: Apr. 2, 2004
(86) PCT No.: PCT/CZ04/00019

§ 371 Date: Jan. 23, 2006

(30) Foreign Application Priority Data
Apr. 3, 2003 (CZ) PUV 2003-14103

(51) Int. Cl. B60R 21/207; B60N 2/42

(52) U.S. Cl. 280/730.1; 280/730.2; 297/216.12

(57) ABSTRACT

Safety airbag located in the headrest of a motor vehicle seat, after its activation the wings extend on both sides of the headrest and forward, while between the wings there is a wedge-shaped area continuing the forward direction.

### TECHNICAL FIELD

The invention relates to the safety air bag, located in the headrest of a motor vehicle seat.

### BACKGROUND ART

The efforts to increase the safety levels for motor vehicle passengers in case of an accident bring good results in protection of human bodies. This is supported by the proper rigid construction of the vehicle cabin as well as by special equipment, mainly the retractor belts with blocking device and pyrotechnical pre-tensioning devices, equipped with load limiter with a deformation element, reducing load in case of a crash and mainly the safety airbags. The driver as well as the co-driver is quite well protected in case of front or rear crashes in the direction of the vehicle axis. But there is still problem with side crashes and also so-called offset crashes—i.e. crashes with direction out of the longitudinal axis of the vehicle. Regardless long deformation distances there always follows a significant movement in opposite direction, caused by flexible deformation. While the body is hold by the safety belts, there occurs a sudden and uncontrolled reverse movement of the head that has sufficient free space around it. The reverse movement of the head frequently leads to a hit to the B-post. The above-described mechanics of the head movement is dangerous even without hitting the hollow parts of the vehicle, as there are extremely loaded the cervical spine vertebrae. The heavy injury may frequently cause even death of the crashed vehicle passenger. The problems of the free head movement are not solved by the existing head rests, consisting of a rigid upholstered structure fixed in the seat rest, by side or other airbags, as there is not anything limiting the head movement in the space among the persons sitting in the vehicle one next to each other. Furthermore, vehicle lower medium and lower class are minimally equipped with airbags and an extra payment is usually charged. That concerns the driver as well as the co-driver on the front seat or passengers on other seats. At the present time, the problems of free head movement are solved using mechanic means—e.g. in such a way that the front part of the rest moves forward in case of straight-on impact. Other solution uses V-organised braces that extend forward from the rest in case of a crash, while the reverse movement of the head is absorbed by a belt stretched between the braces in front of the rest. It emerges that the mechanical devices do not provide sufficient protection in case of lateral offset crashes. This also applies to solutions using airbags filling in the space in front of the rest. In comparison with mechanical devices they are better adjustable to various head positions, but they also do not fulfil their function in case of lateral offset crashes—mainly due to the fact that they do not cover the space among the seats.

To some level, the headrest with built-in telescopic brace, connecting the central and rear wall of the rest frame solves this problem. The front wall is equipped with suspended swivelling wings on lateral sides. The telescopic brace is activated using a pyro-cartridge that moves the front wall forward and it simultaneously releases the suspended wings that swing out to the sides. Such a wing swing-out reduces the space for lateral reverse movement.

The disadvantage of this rest is a relatively long time needed for wings deflection and low-level adaptability to the immediate head position, mainly in extreme cases when—at the moment of crash—the head is out of the rest axis concurrent with the vehicle axis.

### DISCLOSURE OF THE INVENTION

The task of the invention is to maximally eliminate the above-stated imperfections of the headrest, and mainly to reduce the sector of head movement in case of any type of crash and to reduce in this way the risk of passengers' injuries due to uncontrolled head movements immediately after the crash. This can be reached—to a significant level—by a safety airbag organised in the head rest of a motor vehicle in compliance with this technical solution, based on the fact that in case of activation, the wings are created on both sides of the head rest and in front of it, while among the wings there develops a wedge-shaped extending space in front of the rest.

In consideration of safety it is advantageous for the wings to overlap the front side of the rest and to fill in the space between the adjacent lateral side of the vehicle and the adjoining rest.

In consideration of safety it is advantageous for the wings to sit down to the front side of seats in its upper part below the rest.

So as to shorten the head movement trajectory after the crash, it is advantageous for a connecting part to be among the wings and to fill in the space among the wings.

Taking into consideration the maximally simple lay-out it is purposeful for the airbag in compact form to be stored in the headrest holder hollow located in height-adjustable form in the direction of the longitudinal axis of the vehicle.

### BRIEF DESCRIPTION OF DRAWINGS

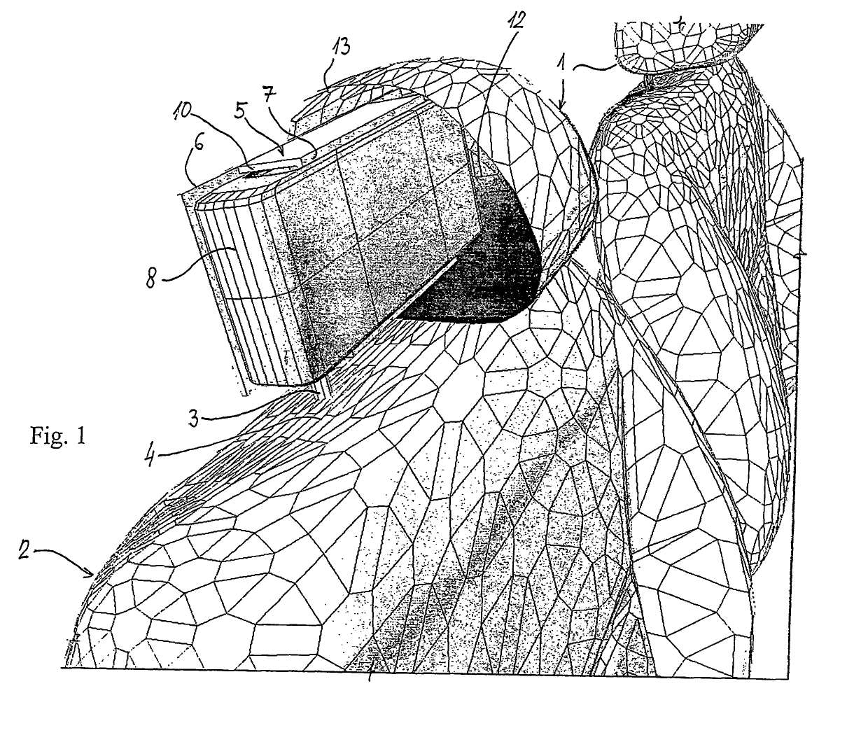

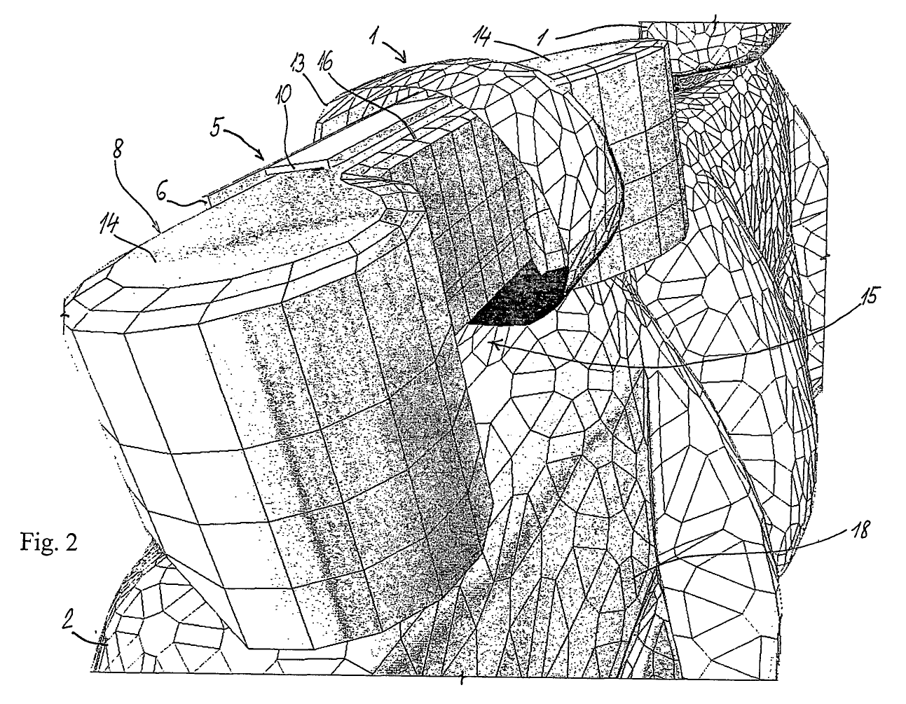

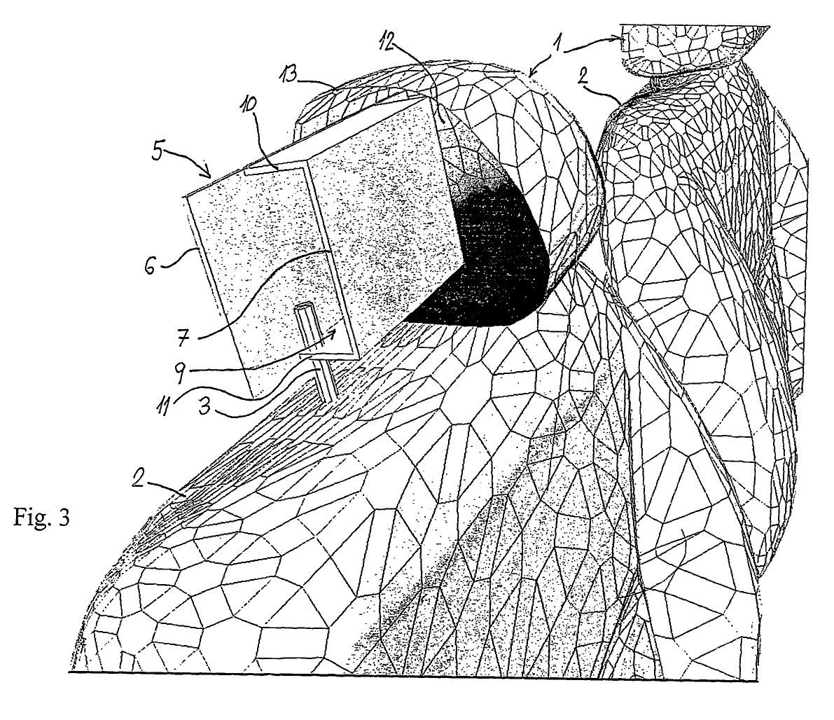

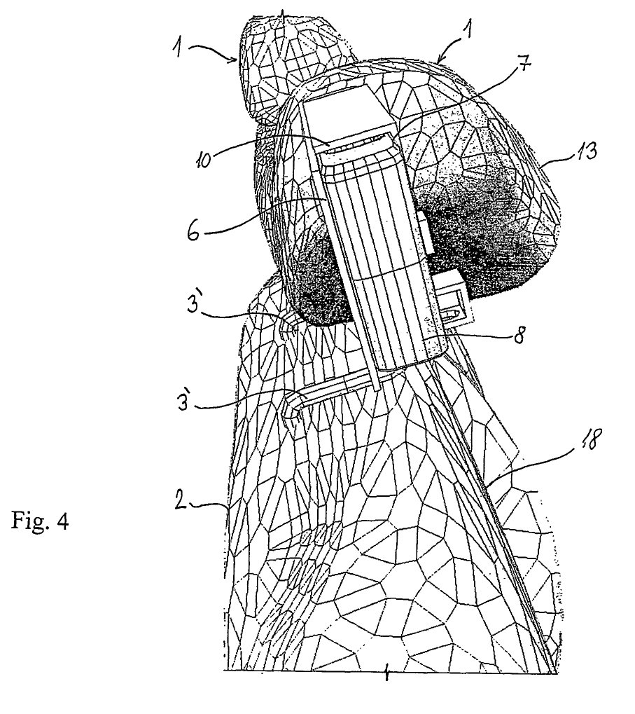

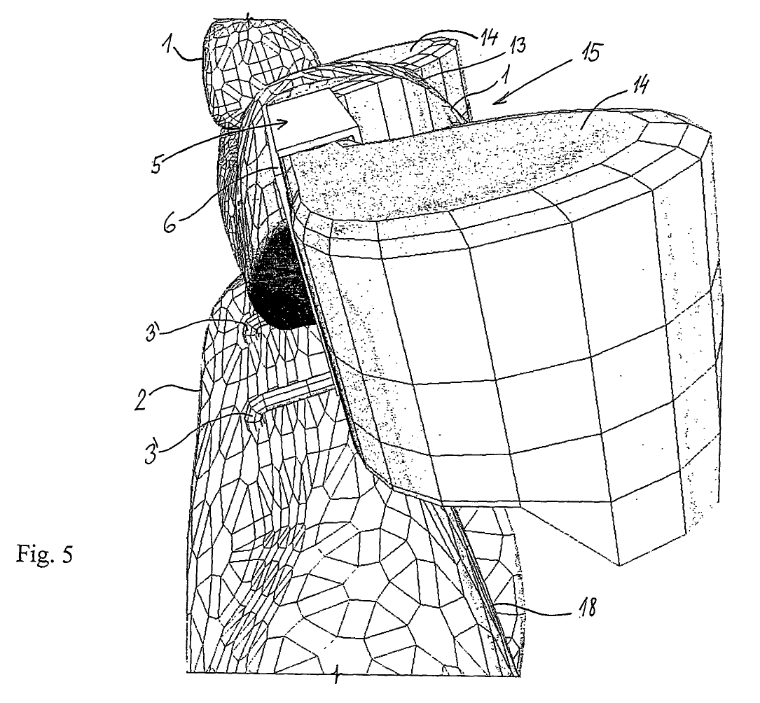

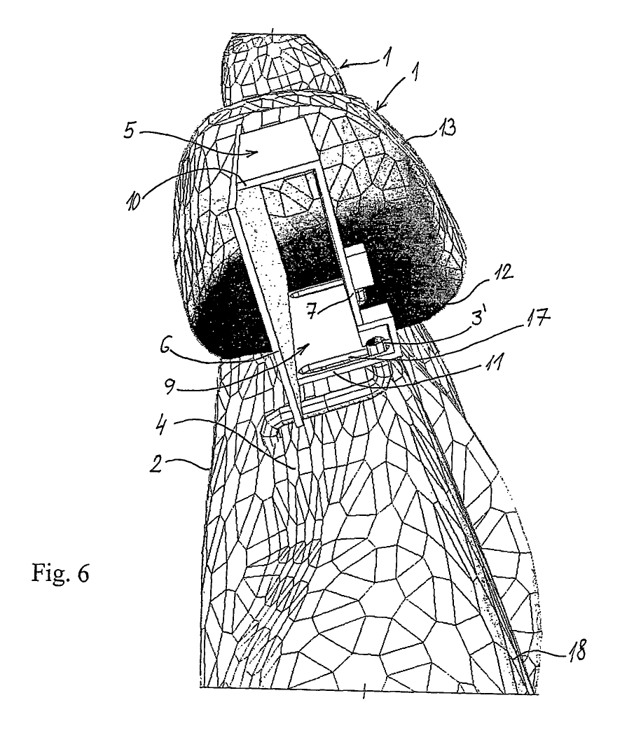

The invention will be explained in detail using drawings, of which FIG. 1 shows an axonometric view of the headrest in partial cut of two neighbour seats, FIG. 2 shows an axonometric view of the headrest according to FIG. 1 after airbag activation, FIG. 3 shows an axonometric view of the headrest according to FIG. 1 after airbag removal, FIG. 4 shows an axonometric view of the alternative version of the headrest in partial cut, FIG. 5 shows an axonometric view of the headrest according to FIG. 4 after airbag activation and FIG. 6 shows an axonometric view of the headrest according to FIG. 4 with dismantled airbag.

### DESCRIPTION OF A PREFERRED EMBODIMENTS

Headrest 1 in version according to FIG. 1 is located on the seat 2 of a motor vehicle in a known way, using a pair of feet 3 flush in the upper surface 4 of the seat 2 and it is usually height-adjustable. The feet 3 are a part of the holder 5, that in this case looks like a case with open sides as you can see in FIG. 3. The rear wall 6 is wider than the front wall 7 of the holder 5 and it serves as a support of the airbag 8. The folded airbag 8 is located in the hollow 2 of the holder 5 and in front of its front wall 7. The external sides of the rear wall 6, upper wall 10 and bottom wall 11 of the holder 5 serve for placement of the core 12 of the headrest 1. The core 12 is usually made of polyurethane foam and it is covered with a covering layer 13 from the outside—usually upholstery. The core 12 of soft foam tissue is equipped with a deformation area on both sides or with a hole that is not shown here and that allows—in case of activation—the airbag 8 unfolding according to FIG. 2. For this purpose, threads making possible disruption make the stitches of the covering layer 13. Together with the airbag 8, the holder 5 area also contains the accessories of the airbag 8, that are generally known and that is why they are not described here. Taking into consideration the coverage of the area between seats and the lateral side of the vehicle, the activated airbag 8 creates wings 14 extending to both sides of the headrest 1 and forward and so they create a wedge-shaped area 15 between them. The wings 14 of the airbag 8 are inter-connected by the connecting piece 16, adjacent to the external side of the front wall 7 of the holder 5.

In case of alternative version according to FIG. 4 the airbag 8 is located in the hollow 9, the headrest 1 is height adjustable as well as adjustable in the direction of the longitudinal axis of the vehicle. With this purpose, the feet 3′ of the headrest 1 are goose-neck deflected above the seat 2 and they are adjustably located in grooves 17 made in the bottom wall 11 of the holder 5. In the example, the whole airbag 8 is located in the hollow 9 of the holder 5 with its front wall 7, rear wall 6 and upper wall 10 created identically with the previously described version.

The holder 5 holds the core 12 equipped with an external layer in a form, allowing tearing in case of activation of the airbag 8 with its wings 14 filling the space between the side wall of the vehicle and wing 14 of the neighbouring headrest 1 airbag 8. The airbag 8 activation is performed simultaneously with activation of other airbags of the vehicle. The airbag 8 is inflated, while there is released the core 12 and the covering layer 13 and the airbag 8 moves out—to both sides of the headrest 1, while the wings 14 create among them the above-mentioned wedge-shaped area 15 that extends from the headrest 1 and the front area of the seat 18. Simultaneously, the wings 14 fill in the space between the headrest 1 and the B-post and the space between the seat on head level. In case of version according to FIG. 1, the connecting part 16 of the airbag 8 is deformed as well as the front part of the core 12, respectively also the covering layer 13, which reduces the space between the head and the headrest 1 between the wings 14.

In case of the alternative version, when the connecting parts 16 among the wings 14 pass through the hollow of the holder 5, the headrest 1 is put into position that is as close as possible to the head of the person sitting on seat 2, which is done by re-adjustment of feet 3′ of the headrest 1 in the groove 5. After activation, the airbag 8 creates only the wings 14, filling the space on both sides of the headrest 1 and among them the wedge-shaped area 15 extending towards the headrest 1 according to FIG. 6. The head of the person that moves backwards after the crash is deflected by the wings 14 to the front side of the headrest 1 and it prevents from uncontrolled hitting of the B—post or the co-driver's head.

In case of both of the versions it is purposeful for the wings 14 to overlap at least the upper part of the front surface of the seat 2.

### INDUSTRIAL APPLICABILITY

The airbag is designed for use in automotive industry with the purpose of passive safety improvement.

1. Safety airbag located in the headrest of a motor vehicle seat, by the fact that after its activation the wings extend on both sides of the headrest and forward, while between the wings there is a wedge-shaped area continuing the forward direction.

2. Safety airbag according to the claim 1, wherein by the fact that the wings overlap a part of the front side of the headrest and they fill in the space between the side wall of the car body and the neighbouring headrests.

3. Safety airbag according to the claim 1, wherein by the fact that the wings adjoin the front side of the seat in its upper part below the headrest.

4. Safety airbag according to claim 1, wherein by the fact that there is a connecting part between the wings.

5. Safety airbag according to claim 1, wherein by the fact that it is located in the hollow of the holder of the headrest.

6. Safety airbag according to claim 1, wherein by the fact that it is located in the hollow of the holder of the headrest with adjustable height and direction of the longitudinal axis of the vehicle.
